(19) United States
(12) Patent Application Publication
(10) Pub. No.: US 2022/0140549 A1
(43) Pub. Date: May 5, 2022

(54) FLEXIBLE FLAT CABLE AND STACK-TYPE BUSBAR INCLUDING THE SAME

(71) Applicant: JINYOUNG GLOBAL Co., Ltd., Seongju-gun (KR)

(72) Inventor: Kyongdo KIM, Suwon-si (KR)

(73) Assignee: JINYOUNG GLOBAL Co., Ltd., Seongju-gun (KR)

(21) Appl. No.: 17/086,677

(22) Filed: Nov. 2, 2020

(51) Int. Cl. H01R 25/14; H01R 43/20; H02G 5/00; H01B 7/04; H01B 13/012; H01B 7/08

(52) U.S. Cl. CPC H01R 25/14; H01R 43/20; H01B 7/0838; H01B 7/04; H01B 13/01254; H02G 5/005

(57) ABSTRACT

A stack-type busbar includes a first layer, a second layer, and a third layer for more efficient heat dissipation.

### FIELD

Embodiments of the present disclosure are applicable to a technical field related to a busbar, and more particularly, relate to a FFC (flexible flat cable) and a stack-type busbar including the same.

### BACKGROUND

Recently, as demand for eco-friendly vehicles and electric vehicles increases, the capacity of batteries is increasing in order to maintain the vehicle for a long time. As the battery capacity increases, a thickness of a cable for delivering power should increase as well. In this case, there is a problem that fuel economy of the vehicle is reduced.

In order to solve this problem, interest in FFC (flexible flat cable) which is flexible and flat that is folded into various shapes and has no limit in terms of selection of the number of strands of conductor wires, and is able to be installed in a small space is rising, compared to a wire harness.

FFC is a cable having a built-in conductor layer composed of a plurality of conductor wires, and acts as a data communication line or a power line that contributes to lighter weight and slimming of various electronic products. FCC is used in various industrial fields including automobiles, medical devices, semiconductor equipment, and computers.

Recently, with spread of next-generation vehicles such as hybrid vehicles or electric vehicles, demand for automotive electronic devices and electric devices that cope with high voltage and high current is increasing. A busbar is a component to connect power to each part of the next-generation automobile.

A busbar functions as a wiring component that is electrically connected to electronic components, or electronic devices such as a motor, an inverter, or a generator. In general, a large current flows through the busbar of a vehicle. However, there are cases in which electronic components, electric devices, or electronic devices allow AC current as well as direct current DC to flow through the busbar.

### SUMMARY

However, when the flexible flat cable (FFC) is designed without considering a cross-sectional area of a metal structure and a type of a film included in the FFC, heat dissipation effect may be lowered, and a weight of the FFC may be increased. Further, when the FFC is manufactured without taking into account a type of a metal conductor included in the metal structure, a cost of the FFC may increase.

Therefore, in manufacturing a busbar including one or more FFCs, FFC having increased heat dissipation effect and having a reduced cost, and a stack type busbar including such FFCs are required.

A first aspect of the present disclosure provides a stack-type busbar including a first layer, a second layer, and a third layer, wherein the first layer is disposed on the second layer, and the second layer is disposed on the third layer, wherein each of the first layer and the third layer includes: two insulating coating layers vertically spaced from each other; a plurality of metal structures disposed between the two insulating coating layers and arranged horizontally and spaced apart from by a predetermined spacing; and an adhesive filled between the two insulating coating layers to fix the plurality of metal structures while surrounding the plurality of metal structures, wherein the second layer has a thickness greater than or equal to a predefined value for heat dissipation of the first layer and the third layer, wherein a spacing between adjacent metal structures included in the first layer is greater than or equal to a spacing between adjacent metal structures included in the third layer.

In one implementation of the stack-type busbar of the first aspect, each of the plurality of metal structures includes one of iron (Fe), sludge metal, and aluminum (Al).

In one implementation of the stack-type busbar of the first aspect, each of the two insulating coating layers has thermal emissivity higher than or equal to thermal emissivity of the adhesive, wherein the adhesive has thermal emissivity higher than or equal to thermal emissivity of each of the plurality of metal structures.

In one implementation of the stack-type busbar of the first aspect, each of the two insulating coating layers includes a polycyclohexane dimethylene terephthalate (PCT) film.

In one implementation of the stack-type busbar of the first aspect, the adhesive includes polyester.

In one implementation of the stack-type busbar of the first aspect, each of the plurality of metal structures has a thickness of 0.2 mm to 0.5 mm and a width of 0.05 mm to 0.15 mm.

In one implementation of the stack-type busbar of the first aspect, each of the first and third layers is formed using: a first lamination process in which heat of a temperature within a range of 100° C. to 110° C. and a pressure within a range of 1 kgf/cm² to 3 kgf/cm² are applied to the two insulating coating layers; and then a second lamination process immediately after the first lamination process in which heat of a temperature within a range of 140° C. to 160° C. and a pressure within a range of 90 kgf/cm² to 110 kgf/cm² are applied to the two insulating coating layers.

In one implementation of the stack-type busbar of the first aspect, the busbar further comprises a reinforcing film formed on an outer face of each of the two insulating coating layers, and located opposite to the metal structures, wherein the reinforcing film is thermally compressed and bonded to each of the two insulating coating layers using a third lamination process in which a temperature in a range of 110° C. to 130° C. and a pressure in a range of 1 kgf/cm² to 3 kgf/cm² are applied to the reinforcing film and each of the two insulating coating layers.

In one implementation of the stack-type busbar of the first aspect, each of metal structures at both ends of an array of the metal structures in a horizontal direction in each of the first layer and the third layer extends outwardly of one of the two insulating coating layers in a horizontal direction.

In one implementation of the stack-type busbar of the first aspect, the busbar further comprises a hollow tube disposed in the second layer, wherein a fluid flows in the hollow tube.

In one implementation of the stack-type busbar of the first aspect, the stack-type busbar further comprises a bridge disposed in the second layer and configured to maintain a spacing between the first layer and the third layer to be equal to or greater than a predefined spacing.

In one implementation of the stack-type busbar of the first aspect, the stack-type bus bar further comprises a connector connected to each of metal structures at both ends of an array of the metal structures in a horizontal direction.

A second aspect of the present disclosure provides a stack-type busbar comprising: a vertical stack of a plurality of flexible flat cables (FFCs); at least one hollow tube sandwiched between vertically adjacent two FFCs of the plurality of FFCs, wherein a fluid flows in the at least one hollow tube to dissipate heat discharged from the plurality of FFCs; and a connector connected to each of both ends of each of the plurality of FFCs, wherein each flexible flat cable (FFC) includes: two insulating coating layers vertically spaced from each other, wherein each of the two insulating coating layers includes a polycyclohexane dimethylene terephthalate (PCT) film; a plurality of metal structures disposed between the two insulating coating layers and arranged horizontally and spaced apart from by a predetermined spacing; and an adhesive filled between the two insulating coating layers to fix the plurality of metal structures while surrounding the plurality of metal structures, wherein each of the plurality of metal structures includes one of iron (Fe), sludge metal, and aluminum (Al).

In one implementation of the stack-type busbar of the second aspect, each of the at least one hollow tube has a polygonal shape.

In one implementation of the stack-type busbar of the second aspect, each of the at least one hollow tube has a circular shape.

In one implementation of the stack-type busbar of the second aspect, each of the at least one hollow tube is made of an insulators or a conductor.

A third aspect of the present disclosure provides a stack-type busbar comprising: a vertical stack of a plurality of flexible flat cables (FFCs); at least one bridge sandwiched between vertically adjacent two FFCs of the plurality of FFCs; and a connector connected to each of both ends of each of the plurality of FFCs, wherein each flexible flat cable (FFC) includes: two insulating coating layers vertically spaced from each other, wherein each of the two insulating coating layers includes a polycyclohexane dimethylene terephthalate (PCT) film; a plurality of metal structures disposed between the two insulating coating layers and arranged horizontally and spaced apart from by a predetermined spacing; and an adhesive filled between the two insulating coating layers to fix the plurality of metal structures while surrounding the plurality of metal structures, wherein each of the plurality of metal structures includes one of iron (Fe), sludge metal, and aluminum (Al), wherein the at least one bridge maintains a spacing between the vertically adjacent two FFCs to be equal to or greater than a predefined spacing.

In one implementation of the stack-type busbar of the third aspect, the bridge includes one or more bent portions.

In one implementation of the stack-type busbar of the third aspect, the bridge is made of a conductor.

In one implementation of the stack-type busbar of the third aspect, the bridge is made of an insulator.

The FFC according to the embodiments has the insulating coating layer formed by laminating the PCT film, thereby to reduce the weight of the FFC, and improve the thermal emissivity of the FFC.

Further, the FFC according to the embodiments includes a metal structure made of not only copper but also various metal conductors such as sludge metal (for example, iron (Fe), so that the manufacturing cost thereof may be reduced.

Further, the FFC according to the embodiments includes the metal structure whose cross-sectional area is adjusted, such that the thermal resistance of the metal structure may be lowered. The FFC according to the embodiments may include the adhesive made of the material having high thermal emissivity to maintain the temperature of the FFC at a constant level.

Moreover, the stack-type busbar according to the embodiments has a stacked structure capable of improving heat dissipation efficiency even though the plurality of FFCs are vertically stacked.

Moreover, the effect of the present disclosure is not limited to the above effects. It should be understood to include all possible effects derived from descriptions of the present disclosure or a configuration as set forth in the claims.

### BRIEF DESCRIPTIONS OF DRAWINGS

FIG. 1 is a schematic side view of a flexible flat cable (FFC) according to embodiments.

FIG. 2 is a cross-sectional view in a long side direction of the FFC according to the embodiments.

FIG. 3 is a graph of each of I²(x) and a reserve resistance R(x) based on a parameter x for a power loss Pₗₒₛₛ.

FIG. 4 is a cross-sectional view in a short side direction of the FFC according to embodiments.

FIG. 5 shows a FFC manufacturing method using a PCT film as an insulating coating layer according to embodiments.

FIG. 6 is cross-sectional views showing portions A and B of FIG. 5.

FIG. 7 shows a FFC manufacturing method using a PCT film as an insulating coating layer according to embodiments.

FIG. 8 shows a FFC manufacturing method using a PCT film as an insulating coating layer according to embodiments.

FIG. 9 shows a FFC manufacturing method using a PCT film as an insulating coating layer according to embodiments.

FIG. 10 is a diagram showing a structure of a stack-type busbar according to embodiments.

FIG. 11 is a schematic side view of a stack-type busbar according to embodiments.

FIG. 12 is a cross-sectional view of a stack-type busbar according to embodiments.

FIG. 13 is a cross-sectional view of a stack-type busbar according to embodiments.

FIG. 14 is a cross-sectional view of a stack-type busbar according to embodiments.

FIG. 15 is a cross-sectional view of a stack-type busbar according to embodiments.

FIG. 16 is a cross-sectional view of a stack-type busbar according to embodiments.

FIG. 17 is a cross-sectional view of a stack-type busbar according to embodiments.

FIG. 18 is a cross-sectional view of a stack-type busbar according to embodiments.

FIG. 19 shows a stack-type busbar according to embodiments.

### DETAILED DESCRIPTION

For simplicity and clarity of illustration, elements in the figures are not necessarily drawn to scale. The same reference numbers in different figures represent the same or similar elements, and as such perform similar functionality. Further, descriptions and details of well-known steps and elements are omitted for simplicity of the description. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure.

Examples of various embodiments are illustrated and described further below. It will be understood that the description herein is not intended to limit the claims to the specific embodiments described. On the contrary, it is intended to cover alternatives, modifications, and equivalents as may be included within the spirit and scope of the present disclosure as defined by the appended claims.

The terminology used herein is for the purpose of describing particular embodiments only and is not intended to limit the present disclosure. As used herein, the singular forms “a” and “an” are intended to include the plural forms as well, unless the context clearly indicates otherwise. It will be further understood that the terms “comprises”, “comprising”, “includes”, and “including” when used in this specification, specify the presence of the stated features, integers, operations, elements, and/or components, but do not preclude the presence or addition of one or more other features, integers, operations, elements, components, and/or portions thereof. As used herein, the term “and/or” includes any and all combinations of one or more of the associated listed items. Expression such as “at least one of” when preceding a list of elements may modify the entirety of list of elements and may not modify the individual elements of the list.

It will be understood that, although the terms “first”, “second”, “third”, and so on may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

In addition, it will also be understood that when a first element or layer is referred to as being present “on” or “beneath” a second element or layer, the first element may be disposed directly on or beneath the second element or may be disposed indirectly on or beneath the second element with a third element or layer being disposed between the first and second elements or layers.

It will be understood that when an element or layer is referred to as being “connected to”, or “coupled to” another element or layer, it may be directly on, connected to, or coupled to the other element or layer, or one or more intervening elements or layers may be present. In addition, it will also be understood that when an element or layer is referred to as being “between” two elements or layers, it may be the only element or layer between the two elements or layers, or one or more intervening elements or layers may also be present.

Further, as used herein, when a layer, film, region, plate, or the like is disposed “on” or “on a top” of another layer, film, region, plate, or the like, the former may directly contact the latter or still another layer, film, region, plate, or the like may be disposed between the former and the latter. As used herein, when a layer, film, region, plate, or the like is directly disposed “on” or “on a top” of another layer, film, region, plate, or the like, the former directly contacts the latter and still another layer, film, region, plate, or the like is not disposed between the former and the latter. Further, as used herein, when a layer, film, region, plate, or the like is disposed “below” or “under” another layer, film, region, plate, or the like, the former may directly contact the latter or still another layer, film, region, plate, or the like may be disposed between the former and the latter. As used herein, when a layer, film, region, plate, or the like is directly disposed “below” or “under” another layer, film, region, plate, or the like, the former directly contacts the latter and still another layer, film, region, plate, or the like is not disposed between the former and the latter.

Unless otherwise defined, all terms including technical and scientific terms used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

A cable described based on embodiments, for example, FFC refers to a conductor that enables electrical connection between components. The cable according to embodiments may be used for electric vehicles, hydrogen electric vehicles, eco-friendly vehicles such as hybrid vehicles, battery packs, military transport equipment, manned/unmanned drones, helicopters, fighters, ESS (Energy Storage Station), solar cells, power transmission lines, ships, building (for example, apartments), etc. However, it will be readily apparent to those of ordinary skill in the art that the cable according to embodiments may be applied to any device which will be developed in the future and in which the cable may be installed. The cable according to embodiments may be referred to as a busbar.

A stack-type busbar as described based on embodiments refers to a stack of cables or FFCs. For example, the stack type busbar according to embodiments has a stack structure of one or more busbars.

Hereinafter, a long side direction of the FFC is referred to as an X-axis direction, a short side direction of the FFC is referred to an Y-axis direction, and a stacking direction of the FFCs is referred to as a Z-axis direction.

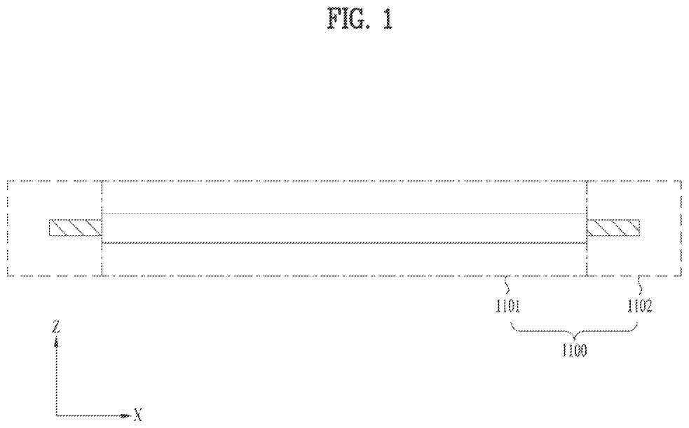

FIG. 1 is a schematic side view of a flexible flat cable (FFC) according to embodiments.

As shown in FIG. 1, a FFC 1100 according to the embodiments may include a main body 1101 and a terminal 1102 at each of both ends of the main body 1101. The main body 1101 may be formed to include an insulator. The terminal 1102 may be formed to include a conductor. That is, the FFC 1100 may be electrically connected to other electronic components, electronic devices, or electric devices through the terminal 1102. A protective cover (not shown) may cover an outer face of the main body 1101 to protect the FFC 1100.

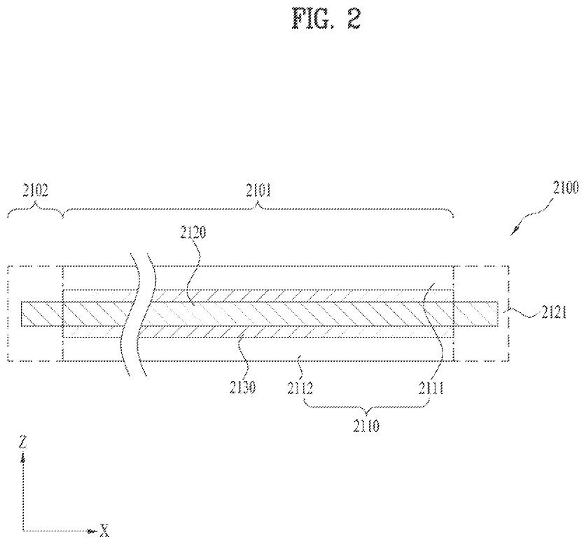

FIG. 2 is a cross-sectional view in the long side direction of the FFC according to the embodiments.

As shown in FIG. 2, a FFC 2100 according to the embodiments (for example, the FFC as described above with reference to FIG. 1) may include two insulating coating layer 2110, a plurality of metal structures 2120 disposed between the two insulating coating layer 2110, and an adhesive 2130. That is, the adhesive 2130 is filled into between the two insulating coating layers 2110 while fixing the plurality of metal structures 2120. Although only one metal structure 2120 is shown in FIG. 2, the disclosure is not limited thereto. The FFCE may include a plurality of metal structures.

The insulating coating layer 2110 according to the embodiments may be embodied as a polyethylene terephthalate (PET) film, a, polycyclohexylene dimethylene terephthalate (PCT) film, and the like.

The insulating coating layer 2110 according to the embodiments has a thermal emissivity of 0.7 or greater to 1 or smaller, preferably 0.75 or greater to 1 or smaller, and particularly preferably, 0.8 or greater to 1 or smaller. Since the insulating coating layer 2110 is installed on an outermost face of the FFC 2100, the thermal emissivity of the insulating coating layer 2110 is preferably greater than that of each of the metal structure 2120 and the adhesive 2130. In particular, it is desirable that the thermal emissivities of the metal structure 2120, the adhesive 2130, and the insulating coating layer 2110 increase in this order. That is, the heat dissipation efficiency is improved by increasing the thermal emissivity at the outside face of the FFC 2100. The metal structure 2120 in FIG. 2 is shown as a single metal structure. The disclosure is not limited thereto. One or more metal structures may be included therein.

The adhesive 2130 according to the embodiments may include, for example, polyester, acrylic, epoxy, or the like.

The adhesive 2130 according to the embodiments is not limited to the above-described example. Any material with excellent chemical resistance, scratch resistance, weather resistance, heat resistance, etc. may be used as the adhesive 230. For example, the adhesive may include a PCT copolymer in which PCT was copolymerized with ethylene glycol (EG) so as to add impact resistance, compared to the PET or PCT material.

The FFC 2100 according to the embodiments may further include a primer (not shown) between the insulating coating layer 2110 and the insulating layer 2120. When applying the primer, the adhesion between the insulating coating layer 2110 and the adhesive 2130 may be improved.

A primer (not shown) may be further included between the insulating coating layer 2110 and the adhesive 2130. When applying the primer, the adhesion between the insulating coating layer 2110 and the adhesive 2130 may be improved.

The FFC 2100 according to embodiments may further include a metal clad 2121 protruding from the insulating coating layer 2110. That is, in the FFC 2100 according to the embodiments, the metal clad 2121 of the metal structure 2120 may be exposed to the outside at both ends in the x-axis direction. When a plurality of FFCs 2100 exist, metal clads 2121 of adjacent FFCs 2100 may contact each other. In this connection, adjacent metal clads 2121 may directly contact each other or may be connected to each other via bonding. Alternatively, the adjacent metal clads 2121 may be connected to each other via a conductive adhesive (not shown). For example, when there are a plurality of FFCs 2100, the metal structures 2120 included in adjacent FFCs 2100 may be electrically connected to each other via the metal clad 2121. The metal clad 2121 may refer to the terminal 2102, for example, the terminal as described above with reference to FIG. 1.

When increasing a surface area of the multiple metal structures 2120, the heat dissipation effect of the FFC 2100 increases, and a weight thereof may be reduced. Hereinafter, a process of determining a cross-sectional area or a surface area of a metal structure at which amounts of current and power are optimized and the heat dissipation effect of the FFC increases will be described.

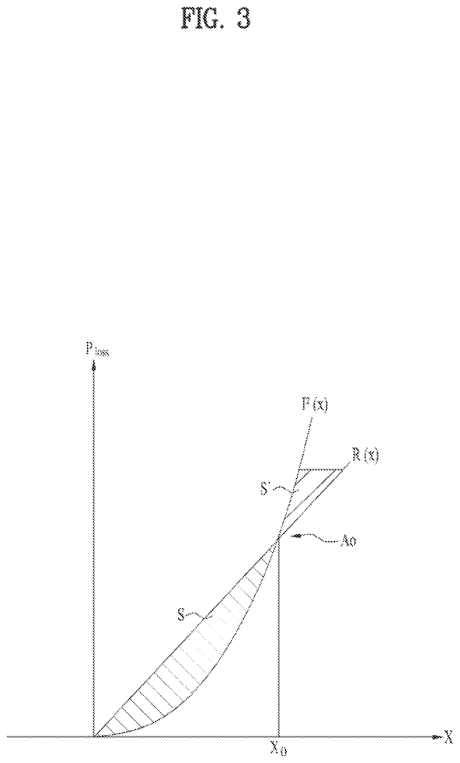

FIG. 3 is a graph of each of I²(x) and a reserve resistance R(x) based on a parameter x for a power loss Pₗₒₛₛ.

The FFC according to embodiments (for example, the FFC as described above with reference to FIGS. 1 to 2) may deliver power. For example, the FFC may transfer power between two electronic devices.

When the FFC supplies power, an entirety of applied power Pₐₚₚₗᵢ supplied to the FFC is not used as real power pᵣₑₐₗ of the FFC. Power loss Pₗₒₛₛ as a loss of electrical energy may occur in the delivery process. [Equation 1] denotes a relationship between the applied power and the power loss.

Pᵣₑₐₗ=Pₐₚₚₗᵢ−Pₗₒₛₛ [Equation 1]

In [Equation 1], Pᵣₑₐₗ denotes real power, Pₐₚₚₗᵢ denotes applied power, and Pₗₒₛₛ denotes power loss.

The real power Pᵣₑₐₗ may be expressed as [Equation 2].

Pᵣₑₐₗ=1−rPₐₚₚₗᵢ [Equation 2]

In [Equation 2], r is a constant representing a relationship between the applied power and the real power.

The FFC according to the embodiments has thermal energy corresponding to the power loss Pₗₒₛₛ expressed in the Equation. The thermal energy is released to the outside of the busbar via heat transfer, heat conduction, convection and heat dissipation.

Heat conduction refers to transfer of heat via a material. A measure of easiness of heat transfer via the material refers to inherent thermal conductivity thereof. Convection refers to heat transfer via fluid flow. Heat dissipation refers to heat transfer via electromagnetic waves. A measure of easiness of heat dissipation through a material refers to specific thermal emissivity thereof. While it is assumed that there is no influence such as convection in the heat transfer through FFC, the specific thermal emissivity and the thermal conductivity may be considered in the heat transfer through FFC. When the thermal conductivity of the material is large, a heat conduction amount therethrough is large. The greater the heat thermal emissivity of the material, the greater the heat dissipation therefrom is large.

Therefore, it is preferable that the conductor included in the FFC is a conductor having high thermal conductivity and high thermal emissivity for heat dissipation.

Each of a plurality of metal structures according to embodiments, for example, the metal structures as described above with reference to FIG. 2 may include a conductor having excellent electrical conductivity. According to the graph shown in FIG. 3, a type of the conductor to be included in the metal structure may be determined. In FIG. 3, Pₗₒₛₛ denotes the power loss, I²(x) denotes a square of current I for a parameter x, and R(x) denotes a resistance.

The power loss Pₗₒₛₛ may be expressed as a following [Equation 3] using the current I and the resistance R.

Pₗₒₛₛ=rI²R [Equation 3]

In [Equation 3], I denotes the current and R denotes the resistance.

As the current I increases, the real power Pᵣₑₐₗ increases. However, as may be seen in [Equation 3], as the current I increases, the power loss Pₗₒₛₛ also increases. For the design of the FFC according to the embodiments, a current I value having a maximum magnitude while suppressing the power loss Pₗₒₛₛ should be considered. That is, the maximum current I at which the current loss of the FFC according to the embodiments is reduced may be considered.

[Equation 3] may be expressed as following [Equation 4] using the parameter x.

I²(x)=a₁x²+b₁x+c₁

R(x)=b₂x+c₂ [Equation 4]

In [Equation 4], I²(x) refers to an equation of a square of the current I for the parameter x. R(x) represents an equation of the resistance R for the parameter x. a₁, b₁, b₂, c₁, and c₂ are constants.

In the graph shown in FIG. 3, the power loss Pₗₒₛₛ expressed in [Equation 4] is expressed as each of the square of the current I²(x) for the parameter x, and the resistance R(x) for the parameter x.

As may be seen in the graph shown in FIG. 3, there is a point A₀ where a curve of I²(x) and a straight line of R(x) meet each other. In a region S left to the point A₀ and a region S′ right to the point A₀, the real power pᵣₑₐₗ is greater than the power loss Pₗₒₛₛ. However, the regions S and S′ have different factors causing the current loss Pₗₒₛₛ. In the region S, a value of the resistance R(x) is larger than a value of the square of the current I²(x), and thus the resistance component may be a dominant factor causing the power loss Pₗₒₛₛ. On the other hand, in the region S′ right to the point A₀, a value of the resistance R(x) is smaller than a value of the square of the current I²(x), and thus the current component may be a dominant factor causing the power loss Pₗₒₛₛ.

That is, it may be seen based on the graph shown in FIG. 3 that the S′ region has a large current loss. Accordingly, the metal structure according to the embodiments may include a conductor capable of reducing the power loss using the current I value corresponding to region S.

The metal structure may include a metal as a conductor, for example, copper (Cu).

In the region S, a total resistance may include specific resistance and thermal resistance. In this connection, percentages of the specific resistance and the thermal resistance in the total resistance are expressed as electrical resistance and thermal conductivity in [Table 1] below. The electrical resistance and the electrical conductivity have an inverse relationship.

TABLE 1

| | Electrical resistance | Thermal conductivity |
|---|---|---|
| Metal types | (at 293 K, μΩcm) | (Wm⁻¹K⁻¹) |
| Sliver | 1.63 | 419 |
| Copper | 1.694 | 397 |
| Aluminum | 2.67 | 238 |
| Iron | 10.1 | 78 |
| Tin | 12.6 | 73 |

[Table 1] shows the electrical resistance and thermal conductivity of each of silver, copper, aluminum, iron, and tin. [Table 1] shows data about only silver, copper, aluminum, iron, and tin in consideration of the total resistance and the cost thereof. However, the metal included in the metal structure according to the embodiments is not limited thereto and may include any material acting as the conductor. As shown in [Table 1], it may be seen that the percentage of the thermal resistance in the total resistance is large enough to ignore the percentage of the specific resistance. Therefore, the metal structure according to the embodiments may be selected in consideration of the thermal resistance. In this connection, the thermal resistance may vary based on a temperature variation. That is, it is preferable that in order to maintain the temperature change, the metal structure included in the FFC according to the embodiments dissipates the heat to maintain a constant temperature.

[Table 2] below shows the above [Table 1] based on the relative electrical conductivity and thermal conductivity of the metal conductor.

TABLE 2

| | Relative electrical | Relative thermal |
|---|---|---|
| | conductivity | conductivity |
| Metal types | (Copper = 100) | (Copper = 100) |
| Sliver | 104 | 106 |
| Copper | 100 | 100 |
| Aluminum | 63 | 60 |
| Iron | 17 | 20 |
| Tin | 13 | 18 |

[Table 2] shows the relative electrical conductivity and thermal conductivity between silver, copper, aluminum, iron, and tin in the region S. Copper has excellent low resistance and has an advantage in terms of the electrical conductivity, and is used as the metal structure included in FFC, but a cost thereof is high and the copper is heavy in weight. Therefore, [Table 2] shows the relative electrical conductivity and thermal conductivity of the remaining metals except for the copper when each of the electrical conductivity of the copper and the thermal conductivity of copper is defined as 100. The relative electrical conductivity and thermal conductivity of silver are higher than those of copper, but the relative electrical conductivity and thermal conductivity of each of the other metals, that is, aluminum, iron and tin are lower than those of the copper. That is, it may be seen that in the region S, the difference between the thermal resistances of the metal conductors is not large.

Accordingly, each of the plurality of metal structures according to embodiments may include at least one of iron (Fe), sludge metal, or aluminum (Al) based on the graph as described above with reference to FIG. 3 and the above related Equations. Iron (Fe), sludge metal, and aluminum (Al) are relatively inexpensive compared to copper and thus allows the manufacturing cost of the FFC to be reduced. Further, in the region S, any metal material acting as the conductor having high thermal resistance other than the above listed materials may be used for the metal structure.

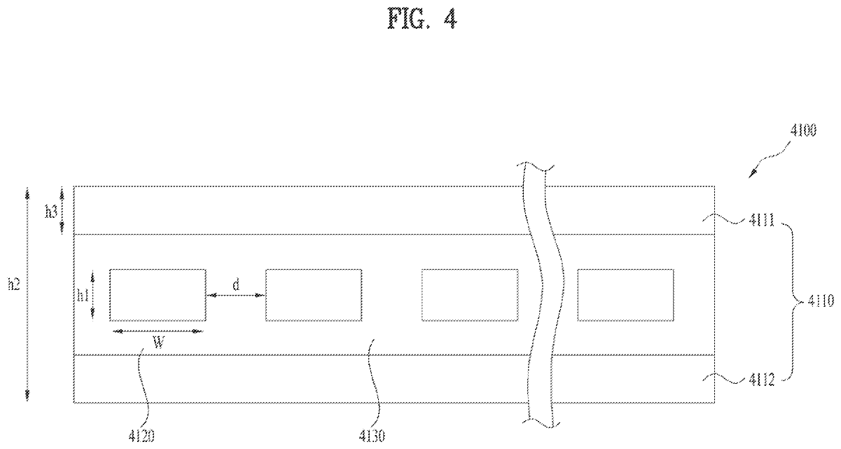

FIG. 4 is a cross-sectional view in the short side direction of the FFC according to embodiments.

A FFC 4100 according to embodiments (for example, the FFC as described above with reference to FIG. 1 to FIG. 3) may include two insulating coating layer 4110 (for example, the insulating coating layers as described above with reference to FIGS. 2 to 3), a plurality of metal structures 4120 disposed between the two insulating coating layers 4110 (for example, the metal structures as described above with reference to FIGS. 2 to 3), and an adhesive 4130 (for example, the adhesive as described above with reference to FIG. 2 to FIG. 3. Descriptions of overlapping configurations therebetween may refer to the above descriptions.

As shown in FIG. 4, the FFC according to the embodiments includes the plurality of metal structures 4120 which are disposed between the two insulating coating layers 4110 and are arranged and spaced apart from each other by a predetermined spacing d, for example, a first spacing d. Since the multiple metal structures 4120 have a smaller weight than that of the bulk metal structure, a proportion of the metal structures in the FFC is reduced. Accordingly, the FFC according to the embodiments may be not only lighter than the FFC including the bulk metal structure (hereinafter, referred to as “rigid FFC”, but also may reduce the manufacturing cost thereof.

Further, the metal structures 4120 according to the embodiments may be disposed between the two insulating coating layers 4110 to reduce heat loss. Specifically, since a long side of the metal structure 4120 according to the embodiments is parallel to a length direction of each of the two insulating coating layers 4110, an area where each metal structure 4120 and the two insulating coating layers 4110 overlap each other may be increased.

A cross-sectional shape of the metal structure 4120 according to embodiments may be a rectangular shape. When the cross-sectional shape of the metal structure 4120 is the rectangular shape, the long side of the rectangular shape parallel to a length direction of the insulating coating layer, that is, to the X-axis direction, and the short side of the rectangle is perpendicular to the length direction of the insulating coating layer 4110, that is, extends in the Z-axis. When constructing the metal structure 4120 in this way, an area where the metal structure 4120 and the insulating coating layers 4110 overlap each other is increased, and the heat loss and the current loss of the FFC 4100 may be reduced. However, the cross-sectional shape of the metal structure 4120 is not limited to the rectangle. The cross-sectional shape of the metal structure 4120 may be any shape, such as an oval, a circle, or a polygon.

When the cross-sectional shape of the metal structure 4120 according to the embodiments is the rectangular shape, a ratio of a length of the long side relative to a length of the short side thereof may be 5 times or greater, preferably 10 times or greater, and particularly preferably 50 times or greater. When the difference between the length in the short side direction and the length in the long side direction thereof increases, the overlapping area between the metal structure 4120 and each insulating coating layer 4110 may be increased at the same cross-sectional area. Therefore, as long as the rigidity of the metal structure 4120 may be maintained, the ratio of the length in the long side direction to the length in the short side direction thereof may be 100 times or greater.

W shown in the drawing represents a width of the metal structure, and h1 shown in the drawing represents a thickness of the metal structure. The width w of the metal structure according to the embodiments has a value in a range of 0.05 mm (50 um) to 0.15 mm (150 um), while the thickness h1 thereof has a value within a range of 0.2 mm (200 um) to 0.5 mm 500 um.

h2 shown in the drawing represents a thickness of the FFC 4100. h3 shown in the drawing represents a thickness of each insulating coating layer 4111 or 4112. For example, the thickness h2 of the FFC has a value in a range of 140 μm to 206 μm, while the thickness h3 of each insulating coating layer 4111 or 4112 has a value within a range of 25 μm to 38 μm. The values of the width w of the metal structure, the thickness h1 of the metal structure, the thickness h2 of the FFC, and the thickness h3 of each of the insulating coating layers 4111 and 4112 are not limited to the above values ranges.

The adhesive 4130 according to the embodiments may be filled into between the two insulating coating layers 4111 and 4112 while surrounding the plurality of metal structures 4120 to fix the plurality of metal structures 4120. In terms of heat loss, in a structure in which the plurality of metal structures 4120 are simply formed between the two insulating coating layers 4111 and 4112, air invading into the FFC 4100 according to the embodiments may be trapped therein. That is, the efficiency of the heat dissipation of the FCC due to the heat emission may be lowered by the intrusive air having low thermal emissivity. Accordingly, the FFC 4100 according to the embodiments may be formed so that a material having high thermal emissivity surrounds the metal structure 4120. Specifically, the FFC 4100 according to the embodiments may be constructed such that the adhesive 4130 having high thermal emissivity that may prevent air intrusion surrounds the plurality of metal structures 4120, while the plurality of metal structures 4120 and the two insulating coating layers 4110 are bonded to each other via the adhesive 4130.

Each of the two insulating coating layer 4110 and the adhesive 4130 according to the embodiments may be made of a material having higher thermal emissivity than that of each of the plurality of metal structures 4120 in order to improve the heat dissipation efficiency of the FCC. For example, the adhesive 4130 may include polyester. The FFC 4100 according to the embodiments may be configured such that the thermal emissivities of the material of the insulating coating layer 4110, the material of the adhesive 4130, and the material of the metal structure 4120 decrease in this order. Therefore, the insulating coating layer 4110 includes a material with relatively high thermal emissivity. The metal structure 4120 may include a material with relatively low thermal emissivity. However, the disclosure is not limited thereto. The materials of the insulating coating layer 4110, the adhesive 4130, and the metal structure 4120 may have the same thermal emissivity.

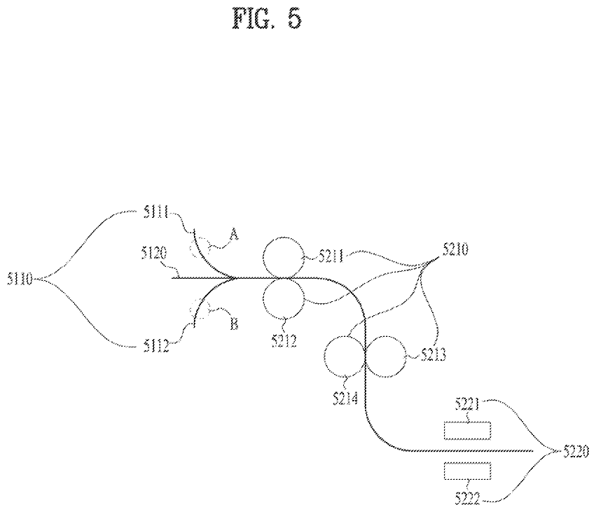

FIG. 5 to FIG. 9 shows the FFC manufacturing method according to the embodiments.

FIG. 5 shows the FFC manufacturing method according to embodiments.

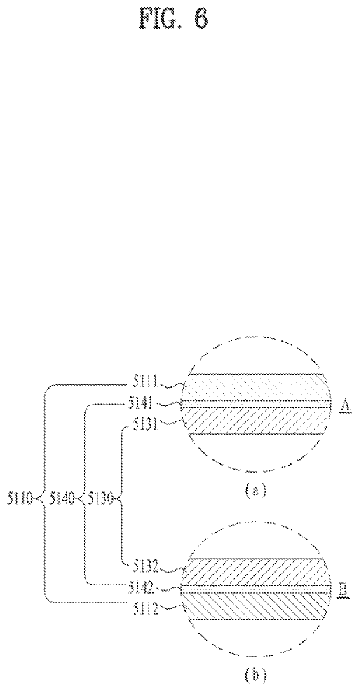

FIG. 6 is a cross-sectional view showing portions A and B of FIG. 5.

As described above with reference to FIG. 1 to FIG. 4, the insulating coating layer 5110 according to the embodiments (for example, the insulating coating layer 2110 as described above with reference to FIG. 2) includes a PCT film. The PCT film has higher heat resistance than that of PET film and has strong properties against high-temperature, high-humidity environments. That is, properties of the PCT film may not change under high-temperature and high-humidity conditions. Therefore, when forming a pattern on the PCT film using a printing method, long-term reliability of the FCC under high temperature and high humidity conditions may be improved, compared to that when forming a pattern on the conventional PET film using a printing method. However, it is difficult to use the PCT film as the insulating coating layer of the FFC because the adhesive strength between the PCT film and the adhesive is low. Hereinafter, a FCC manufacturing method in which the PCT film is used as the insulating coating layer of the FFC will be described.

The manufacturing method of the FFC according to the embodiments, for example, the FFC as described above with reference to FIGS. 1 to 4 includes a lamination process applied during a roll-to-roll process.

In the lamination process according to the embodiments, while a metal structure 5120 as a plurality of strands of conductor wires (for example, the metal structure as described above with reference to FIGS. 2 to 4) may be supplied into between an upper insulating coating layer 5111 and a lower insulating coating layer 5112 (for example, the insulating coating layer as described above with reference to FIGS. 2 to 4), the metal structure may be laminated therebetween.

The insulating coating layer 5110 may include the upper insulating coating layer 5111 and the lower insulating coating layer 5112. A primer 5140 may include an upper primer 5141 and a lower primer 5142. The adhesive 5130 may include an upper adhesive 5131 and a lower adhesive 5132. Thus, as shown in FIG. 5, the upper primer 5141 may be interposed between the upper insulating coating layer 5111 and the upper adhesive 5131, while the lower primer 5142 may be interposed between the lower insulating coating layer 5112 and the lower adhesive 5132.

Each of the upper and lower insulating coating layers 5111 and 5112 refers to a member that will act as each of the upper and lower insulating coating layers 5150 of the FFC 5100. Each of the upper and lower insulating coating layers 5111 and 5112 may be embodied as a PCT film made of PCT. Further, each of the upper and lower primer layers 5141 and 5142 of the FFC may be made of polyurethane-based resin.

When the lamination process according to the embodiments is performed, the upper and lower insulating coating layers 5110 travels while the upper adhesive 5131 of the upper insulating coating layer 5111 and the lower adhesive 5132 of the lower insulating coating layer 5112 are in contact with each other. While the metal structures 5120 are continuously supplied into between the two adhesives 5131 and 5132, the metal structures 5120 may travel together with the upper and lower insulating coating layers 5111 and 5112.

The lamination process according to embodiments includes a first lamination process and a second lamination process.

In the first lamination process according to embodiments, the upper and lower insulating coating layers 5111 and 5112 and the metal structures 5120 travel in a horizontal direction and pass between a pair of first heating rollers 5211 and 5212 arranged vertically. In this connection, the first heating rollers 5211 and 5212 may apply heat of temperature within a range of 100° C. to 110° C. to the upper and lower insulating coating layers 5111 and 5112 and may apply a pressure in a range of 1 kgf/cm² to 3 kgf/cm² thereto. In the first lamination process, the upper and lower insulating coating layers 5111 and 5112 are pressed while alignment of the metal structures 5120 are maintained. Thus, relatively low temperature and low pressure are applied thereto.

In the second lamination according to the embodiments, immediately after the first lamination, the upper and lower insulating coating layers 5111 and 5112 and the metal structures 5120 travels in a vertical direction and pass between a pair of second heating rollers 5213 and 5214 arranged horizontally. In this connection, the second heating rollers 5213 and 5214 may apply heat of a temperature in a range of 140° C. to 160° C. and a pressure in a range of 90 kgf/cm² to 110 kgf/cm² to the upper and lower insulating coating layers 5111 and 5112.

In the second lamination according to embodiments, a case in which the upper and lower insulating coating layers 5111 and 5112 and the metal structures 5120 travel in a horizontal direction may be considered. In this case, when the high temperature heat applied to the lower insulating coating layer 5112 rises, thus affecting the upper insulating coating layer 5111, or when residual heat remaining on the lower insulating coating layer 5112 immediately after the second lamination rises to the upper insulating coating layer 5111, different temperature heats may be applied to the upper and lower insulating coating layers 5111 and 5112. Accordingly, in the second lamination according to embodiments, the upper and lower insulating coating layers 5111 and 5112 and the metal structures 5120 may travel not in the horizontal direction but in a vertical direction.

Alternatively, in the first lamination according to embodiments, the upper and lower insulating coating layers 5111 and 5112 and the metal structures 5120 may travel in a vertical direction. In this case, when the heat temperature increases due to the high temperature of the second heating rollers 5213 and 5214 to affect the environment of the first lamination temperature, the first lamination temperature condition may differ from a target temperature condition. Therefore, in the first lamination according to the embodiments, the upper and lower insulating coating layers 5111 and 5112 and the metal structures 5120 travel in a horizontal direction unlike in the second lamination.

A thickness of each of the upper and lower insulating coating layers 5111 and 5112 and a thickness of each of the metal structures 5120 according to the embodiments are appropriately selected so that a thickness of the FFC according to the embodiments is as described above.

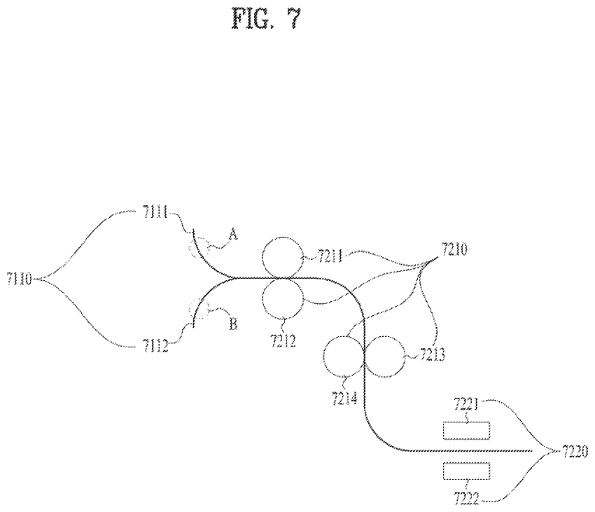

FIG. 7 shows a FFC manufacturing method according to embodiments.

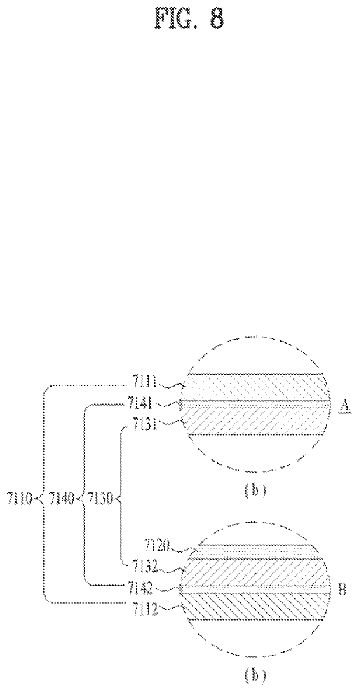

FIG. 8 is a cross-sectional view showing portions A and B of FIG. 7.

The manufacturing method of the FFC according to the embodiments, for example, the FFC as described above with reference to FIGS. 1 to 6 includes a lamination process applied during a roll-to-roll process.

Unlike FIG. 5, in FIG. 7, the metal structures (not shown) may be printed on one of upper and lower adhesives 7131 and 7132 respectively corresponding to upper and lower insulating coating layers 7111 and 7112 before the lamination process is performed. FIG. 7 and (b) in FIG. 8 show that the metal structures 7120 are printed on the lower adhesive 7132 corresponding to the lower insulating coating layer 7112.

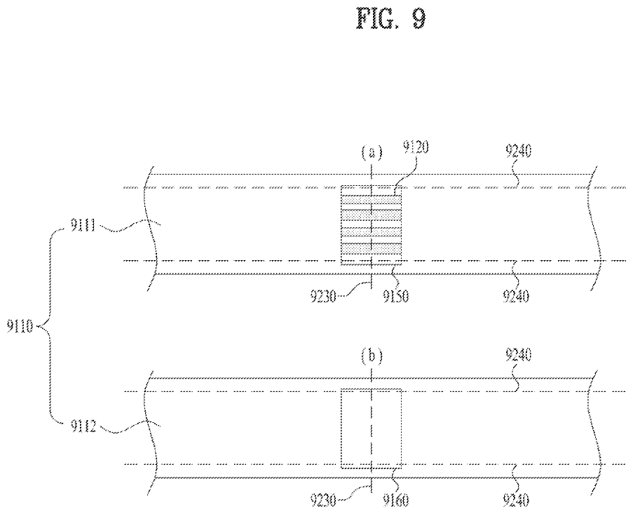

FIG. 9 is a plan view and a bottom view to describe a slitting process and a cutting process performed after the lamination process.

The lamination process according to embodiments, for example, the lamination process as described above with reference to FIGS. 5 to 8 may include a third lamination process performed after the second lamination process.

In the FFC according to the embodiments, for example, the FFC as described above with reference to FIGS. 1 to 8, both ends of each of metal structures 9120 (for example, the metal structures as described above with reference to FIGS. 2 to 8) may be exposed to the outside as described above for connection to a connector (not shown). To this end, an exposure window 9150 may be perforated in one of the upper and lower insulating coating layers 9111 and 9112 (for example, the insulating coating layer as described above with reference to FIGS. 2 to 8) before the lamination process.

After the upper and lower insulating coating layers 9111 and 9112 according to the embodiments (for example, the insulating coating layer as described above with reference to FIG. 2 to FIG. 8) having the exposure window 9150 perforated therein have been subjected to the first and second lamination processes, the third lamination process is performed. In the third lamination process, a reinforcing film 9160 is thermally compressed onto the insulating coating layer 9110 facing the exposure window 9150, that is, the other of the upper and lower insulating coating layers 9111 and 9112. The reinforcing film 9160 according to embodiments may be formed on an outer face of each of the two insulating coating layers 9110. Specifically, the reinforcing film 9160 according to the embodiments may be formed on an outer face of each of the two insulating coating layers 9110 opposite to the plurality of metal structures. As shown in FIG. 9, when the exposure window 9150 is perforated in the upper insulating coating layer 9111, the reinforcing film 9160 may be thermally pressed onto the lower insulating coating layer 9112 so that the film 9160 is located under the exposure window 9150.

In the third lamination process according to the embodiments, the upper and lower insulating coating layers 9111 and 9112 and the metal structures 9120 travel horizontally and continuously while passing between a pair of heating plates 5220 and 7220 arranged vertically (for example, the heating plates as described above with reference to FIGS. 5 to 8). The reinforcing film 9160 is periodically supplied and is thermally compressed to the insulating coating layer 9110 while being periodically pressed and heated by the heating plates 5220 and 7220. The heating plates 5220 and 7220 may apply heat of a temperature within a range of 100° C. to 110° C. and a pressure within a range of 1 kgf/cm² to 3 kgf/cm² to the insulating coating layer 9110 and the reinforcing film 9160.

The reinforcing film 9160 according to the embodiments has a structure in which an adhesive made of a polyester-based resin, for example, the adhesive as described above with reference to FIGS. 2 to 8 is adhered to one face of a PCT film or PET film.

After the third lamination process is achieved, the slitting process and the cutting process may take place sequentially. In the slitting process, both ends in a width direction of the insulating coating layer 9110 are cut along a slitting line 9240 as shown in FIG. 9. After the slitting process is performed, the insulating coating layer 9110 has a width smaller than that of the exposure window 9150. In the cutting process, the insulating coating layer 9110, the metal structures 9120, and the reinforcing film 9160 are cut along a cutting line 9230 located at a center of the exposure window 9150 in a length direction of the FCC.

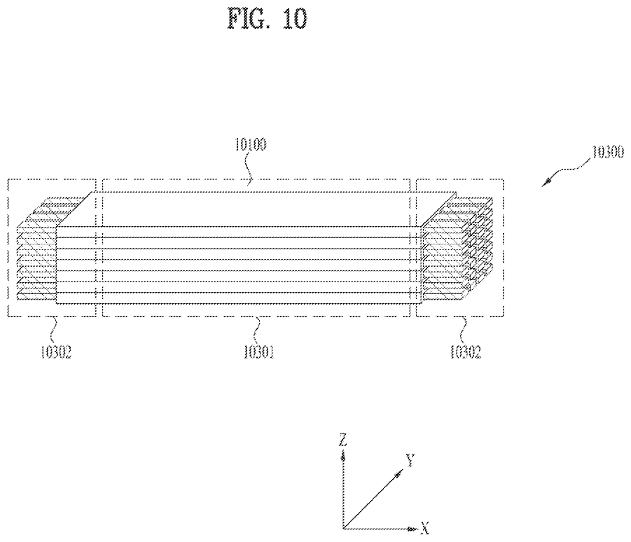

FIG. 10 is a diagram showing a structure of a stack-type busbar according to embodiments.

FIG. 10 is a perspective view of a stack-type busbar 10300 according to embodiments. The stack-type busbar 10300 according to embodiments has a structure in which a plurality of FFCs 10100 (e.g., FFC as described above with reference to FIG. 1 to FIG. 9) are stacked vertically. Further, hereinafter, a long side direction of the FFC is defined as the X-axis direction, a short side direction of the FFC is defined as the Y-axis direction, and the stacking direction of the FFC is defined as the Z-axis direction.

The stack-type busbar 10300 according to the embodiments includes a main body 10301 (e.g., including the main body as described above with reference to FIG. 1 to FIG. 9) and a terminal 10302 at each of both edges of the main body 10301 (e.g., including the terminal as described above with reference to FIG. 1 to FIG. 9. The main body 10301 acts as an insulator. The terminal 10302 acts as a conductor. That is, the stack-type busbar 10100 is electrically connected to other electronic components, electric devices or electronic devices via the terminal 10302. According to the embodiments, in order to protect the FFCs 10100, a protective cover (not shown) may be installed on an outer face of the main body 10301 of the stacked FFCs 10100.

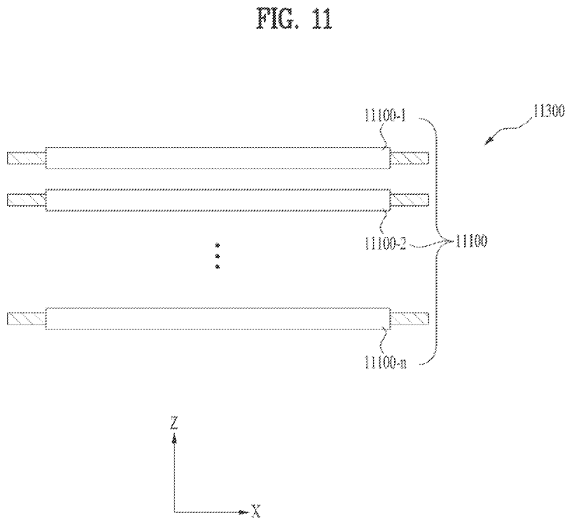

FIG. 11 is a schematic side view of a stack-type busbar according to embodiments.

As shown in FIG. 11, a stack-type busbar 11300 (for example, the stack-type busbar as described above with reference to FIG. 10) has multiple FFCs 11100-1, 11100-2, . . . 11100-n (e.g., including the FFCs as described above with reference to FIG. 1 to FIG. 10) as arranged in the Z-axis direction. In this connection, when the plurality of FFCs are not particularly distinguished from each other, the plurality of FFCs are collectively referred to as FFCs 11100 for convenience of the description. That is, in the stack-type busbar, FFCs as described above with reference to FIGS. 1 to 10 are stacked along n layers in the Z-axis direction.

FIG. 11 shows that adjacent FFCs are spaced apart from each other in the stack-type busbar 11300 for convenience of description. However, the adjacent FFCs do not need to be spaced apart from each other. That is, some of adjacent FFCs may be in contact with each other. Further, the adjacent FFCs may be adhered to each other via an adhesive.

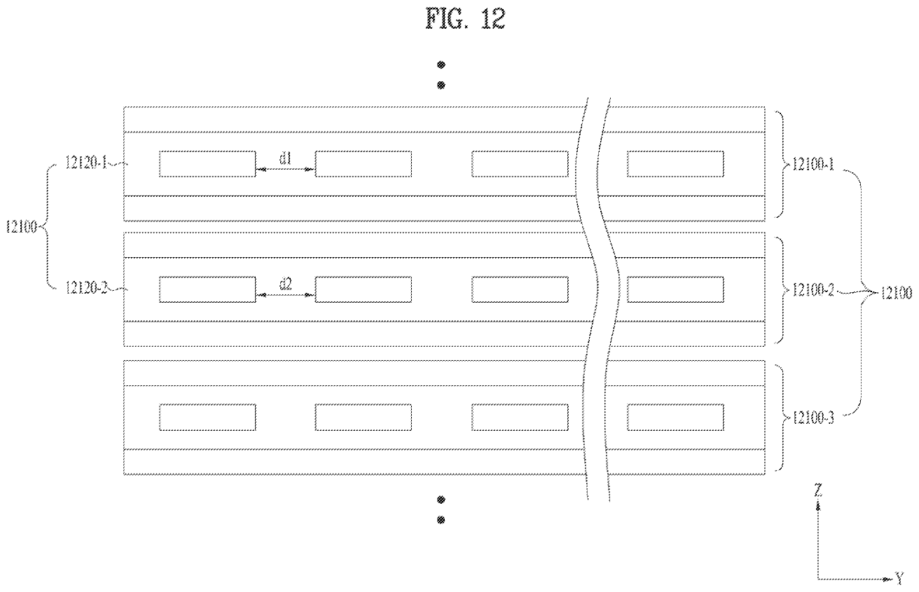

FIG. 12 is a cross-sectional view of a stack-type busbar according to embodiments.

A stack-type busbar 12300 according to embodiments, for example, the stack-type busbar as described above with reference to FIG. 10 to FIG. 11 includes a plurality of FFCs 12100, for example, FFCs as described above with reference to FIGS. 1 to 11. The plurality of FFCs 12100 according to embodiments may include a first FFC 12100-1 and a second FFC 12100-2. Each of the first and second FFCs 12100-1 and 12100-2 is the same as or similar to the FFC as described above with reference to FIGS. 1 to 11, and thus has the two insulating coating layers (for example, the PCT films as described above with reference to FIGS. 1 to 11), the plurality of metal structures (for example, the metal structures as described above with reference to FIGS. 1 to 11), and the adhesive (for example, the adhesive as described above with reference to FIGS. 1 to 11). The stack-type busbar 12300 according to embodiments has a structure in which the first FFC 12100-1 and the second FFC 12100-2 are stacked vertically. Further, the second FFC 12100-2 is stacked on a third FFC 12100-3. The third FFC 12100-3 according to the embodiments may be the same as the first FFC 12100-1, and may be the same as the second FFC 12100-2.

The stack-type busbar 12300 according to embodiments including the plurality of FFCs (collectively referred to as 12100) may be different from a busbar (hereinafter referred to as “rigid busbar”) including a bulk metal structure. However, in the stack-type busbar 12300 according to embodiments, a bulk metal structure is divided into the plurality of metal structures. For example, a single FFC having the plurality of metal structures as divided as described above with reference to FIG. 4 may constitute a single busbar. That is, the stack-type busbar 12300 according to the embodiments may have a reduced total amount of a metal occupied therein, compared to the rigid busbar, thereby implementing a lightweight stack-type busbar at a reduced cost.

Therefore, the stack-type busbar 12300 according to the embodiments has excellent flexibility because the plurality of divided metal structures are stacked, which is not the case in the rigid busbar. In the rigid busbar, when there is a bent portion, a significant amount of heat is generated in the bent portion when power is applied therethrough, thus dissipating a larger amount of power than when the rigid busbar is not bent. To the contrary, even when the stack-type busbar according to the embodiments is bent, there is substantially no power loss due to the bending. Therefore, the stack-type busbar 12300 according to the embodiments has many advantages over the rigid busbar. For example, the stack-type busbar 12300 may suppress rise in a temperature when a large current flows therein.

The stack-type busbar 12300 according to embodiments includes the first FFC 12100-1 and the second FFC 12100-2 stacked on the first FFC 12100-1.

Each of the first FFC 12100-1 and the second FFC 12100-2 may include the two insulating coating layers as described above with reference to FIG. 4 (for example, the two insulating coating layers as described above with reference to FIGS. 2 to 11) (for example, the two insulating coating layers 4111 and 4112 in FIG. 4), and the plurality of metal structures 12120 (for example, the plurality of metal structures 4120 as described above with reference to FIG. 4) arranged between the two insulating coating layers. The plurality of metal structures 12120 may be surrounded with and fixed to the adhesive, for example, the adhesive 4130 as described above with reference to FIG. 4. That is, the adhesive may be located between the insulating coating layer and the metal structure 12120 or between adjacent metal structures 12120. The structure of the FFC in the stack-type busbar 12300 according to embodiments is the same as that as described above with reference to FIG. 4, and thus the detailed description thereof is omitted.

Each of a first spacing d1 and a second spacing d2 shown in FIG. 12 represents a spacing between adjacent metal structures within the same FFC.

As shown in FIG. 12, a plurality of metal structures 12120-1 included in the first FFC 12100-1 according to embodiments may be disposed between the two insulating coating layers, and may be arranged in the Y direction and be spaced apart from each other by a first spacing d1.

As shown in FIG. 12, a plurality of metal structures 12120-2 included in the second FFC 12100-2 according to embodiments may be disposed between the two insulating coating layers, and may be arranged in the Y direction and be spaced apart from each other by a first spacing d2.

The second spacing d2 may be the same as or different from the first spacing d1. Although not shown in the drawing, the plurality of metal structures included in the third FFC 12120-3 according to embodiments may be disposed between the two insulating coating layers, and may be arranged in the Y direction and be spaced apart from each other by a third spacing. The third spacing may be the same as or different from the first spacing d1 and/or the second spacing d2.

The plurality of metal structures 12120 according to the exemplary embodiments are arranged and spaced apart from each other, thereby improving the heat dissipation effect of the FFC 12100.

A cross-sectional shape of each of the metal structure 12120 according to embodiments may be a rectangular shape. When the cross-sectional shape of the metal structure 12120 is the rectangular shape, the long side of the rectangular shape parallel to a length direction of the insulating coating layer, that is, to the X-axis direction, and the short side of the rectangle is perpendicular to the length direction of the insulating coating layer, that is, extends in the Z-axis. When constructing the metal structure 12120 in this way, an area where the metal structure 12120 and the insulating coating layers overlap each other is increased, and the heat loss and the current loss of the FFC 12100 may be reduced. However, the cross-sectional shape of the metal structure 12120 is not limited to the rectangle. The cross-sectional shape of the metal structure 12120 may be any shape, such as an oval, a circle, or a polygon.

When the cross-sectional shape of the metal structure 12120 according to the embodiments is the rectangular shape, a ratio of a length of the long side relative to a length of the short side thereof may be 5 times or greater, preferably 10 times or greater, and particularly preferably 50 times or greater. When the difference between the length in the short side direction and the length in the long side direction thereof increases, the overlapping area between the metal structure 12120 and each insulating coating layer may be increased at the same cross-sectional area. Therefore, as long as the rigidity of the metal structure 12120 may be maintained, the ratio of the length in the long side direction to the length in the short side direction thereof may be 100 times or greater.

The metal structure 12120 according to the embodiments may include at least one of iron (Fe), sludge metal, or aluminum (Al) as described above with reference to FIGS. 1 to 11. However, the disclosure is not limited thereto. Any metal acting as a conductor may be used for the metal structure 12120. Description of the overlapping configuration therebetween may refer to the above description.

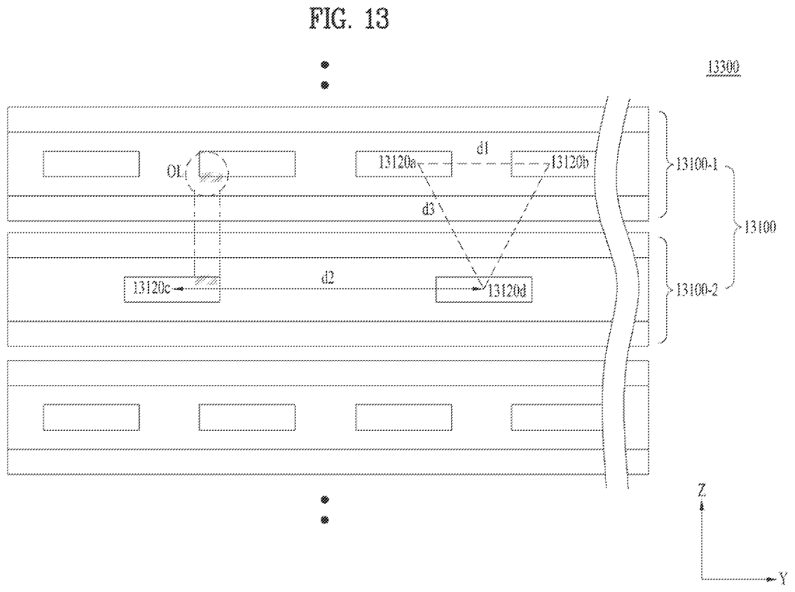

FIG. 13 is a cross-sectional view of a stack-type busbar according to embodiments.

A stack-type busbar 13300 according to embodiments (for example, the stack-type busbar as described above with reference to FIG. 10 to FIG. 12) may include a plurality of FFCs 13100 (for example, the FFCs as described above with reference to FIG. 1 to FIG. 12). The plurality of FFCs 13100 may include a first FFC 13100-1 and a second FFC 13100-2. Each of the first and second FFCs 13100-1 and 13100-2 may include two insulating coating layers, (for example, PCT films as described above with reference to FIGS. 1 to 12), a plurality of metal structures (for example, the metal structures as described above with reference to FIGS. 1 to 12), and an adhesive (for example, the adhesive as described above with reference to FIGS. 1 to 11). The overlapping configuration therebetween may refer to the above description. The stack-type busbar 13300 according to embodiments includes a stack of the first FFC 13100-1 and the second FFC 13100-2. The first FFC 13100-1 may include a plurality of metal structures 13120 spaced apart by a first spacing d1. The first spacing d1 according to the embodiments refers to a spacing between a center of one metal structure (hereinafter, a first metal structure 13120a) included in the first FFC 13100-1 and a center of another metal structure (hereinafter, a second metal structure 13120b) therein adjacent to the first metal structure. The second FFC 13100-2 may include a plurality of metal structures 13120 spaced apart by a second spacing d2. The second spacing d2 according to the embodiments refers to a spacing between a center of one metal structure (hereinafter, a third metal structure 13120d) included in the second FFC 13100-2 and a center of another metal structure (hereinafter, a fourth metal structure 13120c) therein adjacent to the third metal structure. The second spacing d2 according to embodiments may be greater than or equal to the first spacing d1.

The stack-type busbar 13300 according to the embodiments includes the first FFC 13100-1 and the second FFC 13100-2 stacked vertically such that a spacing between at least one of at least two adjacent metal structures included in the first FFC 13100-1 and any metal structure included in the second FFC 13100-2 has the shortest distance, so that internal heat in the busbar may be more efficiently discharged out of the busbar.

D3 in FIG. 13 refers to a third spacing which means the shortest spacing between the metal structure included in the first FFC 13100-1 and the metal structure included in the second FFC 13100-2. That is, the third spacing d3 according to embodiments refers to the shortest spacing between a center of the first metal structure 13120a included in the first FFC 13100-1 and a center of the third metal structure 13120d included in the second FFC 13100-2.

Accordingly, a spacing between the center of the first metal structure 13120a included in the first FFC 13100-1 and the center of the third metal structure 13120d included in the second FFC 13100-2 may be the third spacing d3. That is, the first FFC 13100-1 and the second FFC 13100-2 according to the embodiments may be stacked vertically such that an triangle is created by connecting the center of the first metal structure 13120a, the center of the second metal structure 13120b, and the center of the third metal structure 13120d with each other. The triangular structure according to the embodiments may be referred to as a delta structure.

Any metal structure included in the first FFC 13100-1, for example, the first metal structure 13120a, and any metal structure included in the second FFC 13100-2, for example, the third metal structure 13120d may at least partially overlap (OL) or may not overlap each other in the Z-axis direction, based on the first spacing d1, the second spacing d2 and/or the third spacing d3 according to the embodiments.

When any metal structure included in the first FFC 13100-1 and any metal structure included in the second FFC 13100-2 defining the triangular structure according to the embodiments at least partially overlap each other, the stack-type busbar 13300 may deliver power more effectively. To the contrary, when any metal structure included in the first FFC 13100-1 and any metal structure included in the second FFC 13100-2 defining the triangular structure according to the embodiments do not overlap each other, overlapping between the heat regions of layers of the stack may be minimized. Therefore, the stack-type busbar 13300 may dissipate heat more effectively. As the first spacing d1, the second spacing d2 and/or the third spacing d3 according to the embodiments increases, any metal structure included in the first FFC 13100-1 and any metal structure included in the second FFC 13100-2 do not overlap each other in the z-axis direction.

The structure of the stack-type busbar 13300 according to the embodiments is not limited to the above-described example. In another example, a plurality of first FFCs 13100-1 and a plurality of second FFCs 13100-2 may be alternately and vertically stacked with each other. Alternatively, one first FFC 13100-1 and a plurality of second FFCs 13100-2 may be alternately and vertically stacked with each other. Alternatively, a plurality of first FFCs 13100-1 and one second FFC 13100-2 may be alternately and vertically stacked with each other. Alternatively, a third FFC different from the first FFC 13100-1 and the second FFC 13100-2, (for example, the third FFC 12100-3 as described above with reference to FIG. 12), and the first FFC 13100-1 and the second FFC 13100-2 may constitute a stack.

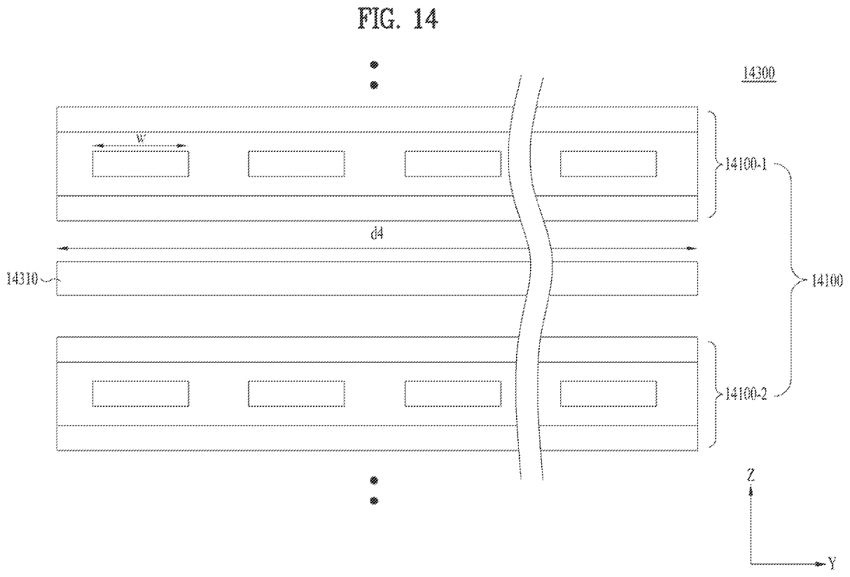

FIG. 14 is a cross-sectional view of a stack-type busbar according to embodiments.

A stack-type busbar 14300 according to embodiments (for example, the stack-type busbar as described above with reference to FIG. 10 to FIG. 13) may include a plurality of FFCs 14100 (for example, the FFCs as described above with reference to FIG. 1 to FIG. 13). The plurality of FFCs 14100 may include a first FFC 14100-1 and a second FFC 14100-2. Each of the first and second FFCs 14100-1 and 14100-2 may include two insulating coating layers, (for example, PCT films as described above with reference to FIGS. 1 to 13), a plurality of metal structures (for example, the metal structures as described above with reference to FIGS. 1 to 13), and an adhesive (for example, the adhesive as described above with reference to FIGS. 1 to 13). The overlapping configuration therebetween may refer to the above description.

The first FFC 14100-1 may include a plurality of metal structures spaced apart from each other by a first spacing, for example, the first spacing d1 as described above with reference to FIG. 12 to FIG. 13. The second FFC 14100-2 may include a plurality of metal structures spaced apart from each other by a second spacing, for example, the second spacing d2 as described above with reference to FIGS. 12 to 13. The second spacing according to the embodiments may be greater than or equal to the first spacing. The stack-type busbar 14300 according to the embodiments includes a meal planar plate 14310 disposed between at least two FFCs, for example, the first FFC 14100-1 and the second FFC 14100-2. d4 shown in FIG. 14 represents a length of the meal planar plate 14310 in a short side direction, that is, in the Y direction. w shown in FIG. 14 represents a length in the short side direction of the metal structure included in the FFC, for example, the first FFC 14100-1. d4 according to embodiments is greater than or equal to w. The stack-type busbar 14100 according to the embodiments may supply high power. Specifically, since a total area of the conductor region is increased due to the presence of the meal planar plate 14310, the number of the stacked FFCs 14100 included in the stack-type busbar 14300 according to the embodiments may be reduced. Therefore, the stack-type busbar 14300 including the meal planar plate 14310 as shown in FIG. 14 is more effective in high current or high power deliver situations.

The meal planar plate 14310 according to the embodiments includes a thin plate-shaped metal and/or a bulk metal. The meal planar plate 14310 may be made of the same material as the metal structure. For example, the metal structure and the meal planar plate 14310 may be made of iron (Fe). However, the disclosure is not limited thereto. The meal planar plate 14310 may be made of any metal as long as it acts as a conductor. For example, regardless of a metal type of the metal structure, the meal planar plate 14310 may be made of copper (Cu), aluminum (Al), silver (Ag), or the like.

A cross-sectional area along the z-axis direction of the meal planar plate 14310 according to the embodiments may be larger than the cross-sectional area in the z-axis direction of the metal structure 14120 included in the plurality of FFCs 14100. Specifically, a length of the metal structure in the y-axis direction as the short side direction may be smaller than a length of the meal planar plate 14310 in the y-axis direction as the short side direction. Further, the surface area of the meal planar plate 14310 may be smaller than a total surface area of the plurality of metal structures included in each of the plurality of FFCs 14100.

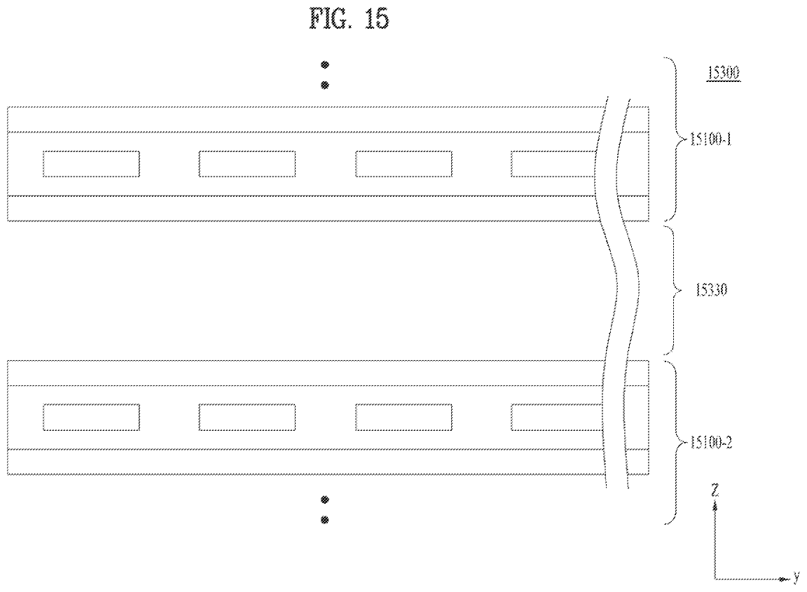

FIG. 15 is a cross-sectional view of a stack-type busbar according to embodiments.

A stack-type busbar 15300 (for example, the stack-type busbar as described in FIGS. 10 to 14) according to embodiments may include one or more layers. A layer according to embodiments refers to a stacking unit of a stack-type busbar, and one layer may include one or more FFCs (for example, FFCs as described in FIGS. 1 to 14). Further, the layer according to the embodiments may include a hollow tube, a conductor, and another type of an object other than the FFC for efficient heat dissipation of the stack-type busbar.

FIG. 15 shows a stack-type busbar 15300 composed of three layers, that is, a first layer 15100-1, a second layer 15330 and a third layer 15100-2.

Each of the first layer 15100-1 and the third layer 15100-2 according to embodiments may include one FFC as shown in FIG. 15. The first layer 15100-1 or the third layer 15100-2 according to the embodiments includes, for example, any one of the first FFC, the second FFC, and the third FFC as described in FIGS. 12 to 14. In addition, each of the first layer 15100-1 and the third layer 15100-2 may include at least two or more FFCs. For example, the first layer 15100-1 or the third layer 15100-2 according to the embodiments may include the stacked FFCs (for example, the stack-type busbar) as described in FIGS. 12 to 14. The first layer 15100-1 according to embodiments may be disposed above the third layer 15100-2. That is, as shown in the drawing, the first layer 15100-1 is disposed above the third layer 15100-2 along the z-axis.

The second layer 15330 according to the embodiments may be disposed between the first layer 15100-1 and the third layer 15100-2. That is, along the z-axis, the first layer 15100-1 may be disposed on the second layer 15330 and the second layer 15330 may be disposed on the third layer 15100-2.

Since each of the first layer 15100-1 and the third layer 15100-2 includes the FFCs as described in FIGS. 1 to 14, efficient heat dissipation is possible even if they are stacked to be adjacent to each other. Further, when the first layer 15100-1 and the third layer 15100-2 are stacked to have a spacing therebetween, the stack-type busbar 15300 including the first layer 15100-1 and the third layer 15100-2 may dissipate heat more efficiently. Therefore, the stack-type busbar 15300 according to the embodiments includes the second layer 15330. The second layer 15330 according to the embodiments may have a thickness greater than or equal to a preset value (for example, a thickness of one FFC) for heat dissipation. That is, the spacing between the first layer 15100-1 and the third layer 15100-2 due to the presence of the second layer 15330 therebetween may be greater than or equal to a preset value. The second layer 15330 according to the embodiments may include a hollow tube, a conductor, or another type of an object other than the FFC for efficient heat dissipation of the stack-type busbar. Thus, heat generated from the plurality of FFCs (for example, the first layer 15100-1 and the third layer 15100-2) may be discharged to the outside through the second layer. That is, due to the spacing between the first layer 15100-1 and the third layer 15100-2, heat generated from the plurality of FFCs may be discharged to the outside.

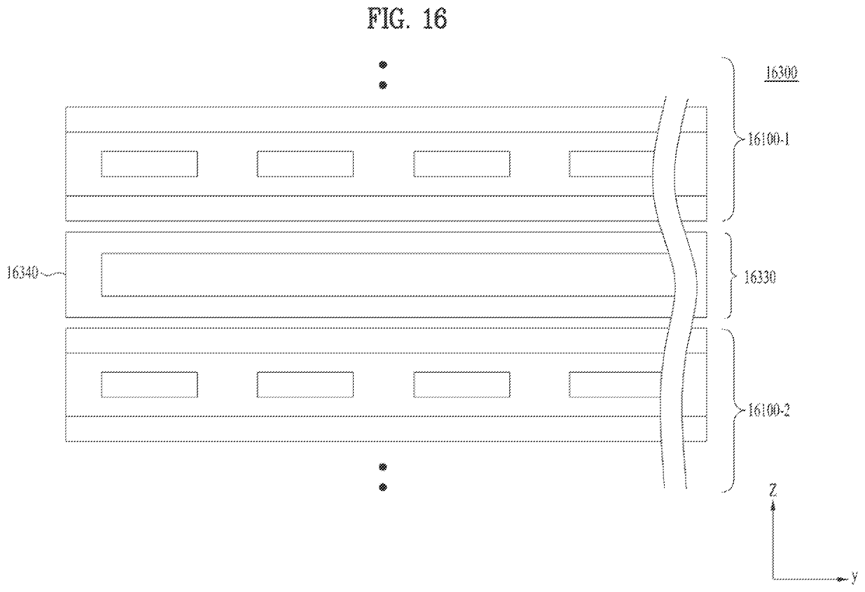

FIG. 16 is a cross-sectional view of a stack-type busbar according to embodiments.

A stack-type busbar 16300 (for example, the stack-type busbar as described in FIGS. 10 to 15) according to the embodiments may include one or more layers (for example, the layer as described in FIG. 15). FIG. 16 shows the stack-type busbar 16300 composed of three layers, namely, a first layer 16100-1 (for example, the first layer 15100-1 as described in FIG. 15, a second layer 16330 (for example, the second layer 15330 as described in FIG. 15), and a third layer 16100-2 (for example, the third layer 15100-2 described in FIG. 15).

The first layer 16100-1 and the third layer 16100-2 shown in FIG. 16 are the same as the first layer 15100-1 and the third layer 15100-2 as described in FIG. 15, respectively, Thus, detailed descriptions thereof are omitted.

The second layer 16330 according to the embodiments may include a hollow tube 16340. FIG. 16 shows one hollow tube 16340. However, the disclosure is not limited thereto. The hollow tube 16340 according to the embodiments may include one or more hollow tubes. The hollow tube 16340 according to the embodiments may be disposed to be fitted into between the first layer 16100-1 and the third layer 16100-2. That is, the hollow tube 16340 according to the embodiments is disposed between the FFC of the first layer 16100-1 and the FFC of the third layer 16100-2. The FFC of the first layer 16100-1 adjacent to the hollow tube 16340 according to embodiments may be a FFC disposed at a bottom of the first layer 16100-1 along the z-axis. The FFC of the third layer 16100-2 adjacent to the hollow tube 16340 according to the embodiments may be a FFC disposed at a top of the third layer 16100-2 along a z-axis. The hollow tube 16340 according to the embodiments may dissipate heat discharged from the plurality of FFCs included in each of the first layer 16100-1 and the third layer 16100-2 or the stacked FFCs adjacent to the hollow tube 16340 to the outside. It may be difficult to dissipate heat generated from the plurality of FFCs only using air at room temperature located inside the hollow tube 16340 according to embodiments. In this case, heat may be released by flowing a fluid such as cooled air or water into the hollow tube 16340 according to the embodiments.

A cross-sectional shape of the hollow tube 16340 according to the embodiments may be a quadrangular shape (hereinafter, referred to as a “rectangular hollow tube”). However, the present disclosure is not limited thereto. The cross-sectional shape of the hollow tube 16340 may be a polygonal shape such as a triangle or a pentagon. The rectangular hollow tube 16340 may be embodied as a single large hollow tube 16340, as shown in FIG. 16. However, the disclosure is not limited thereto. Although not shown, the rectangular hollow tube 16340 may be embodied as a plurality of small rectangular hollow tubes.

The hollow tube 16340 according to the embodiments may be made of a conductor. The stack-type busbar 16300 including the hollow tube 16340 according to the embodiments may supply high power. Specifically, the hollow tube 16340 made of the conductor increases a percentage of a conductor included in the stack-type busbar 16300 according to the embodiments, thereby supplying greater power.

The hollow tube 16340 according to the embodiments may be made of an insulator. When the hollow tube 16340 according to the embodiments itself has an insulating effect, it is possible to suppress generation of an electric force between the FFC of the first layer 16100-1 and the FFC of the third layer 16100-2. Therefore, the hollow tube 16340 may suppress an attracting force between the FFC of the first layer 16100-1 and the FFC of the third layer 16100-2 via the electric force, such that a spacing between the first layer 16100-1 and the third layer 16100-2 may be further widened. Thus, the stack-type busbar 16300 including the hollow tube 16340 according to embodiments may more effectively reduce the heat existing in the stack-type busbar 16300.

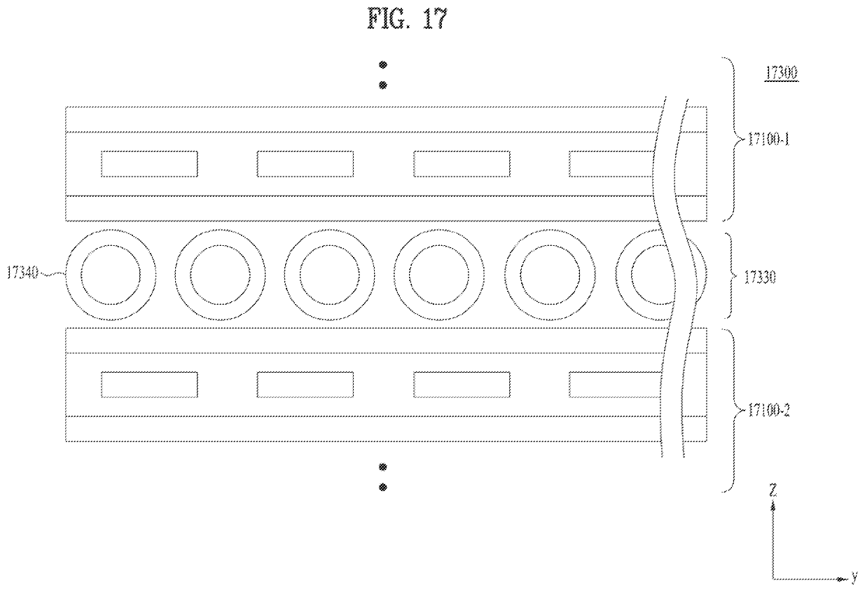

FIG. 17 is a cross-sectional view of a stack-type busbar according to embodiments.

A stack-type busbar 17300 (for example, the stack-type busbar as described in FIGS. 10 to 16) according to the embodiments may include one or more layers (for example, the layer described in FIG. 15). FIG. 17 shows the stack-type busbar 17300 composed of three layers, namely, a first layer 17100-1 (for example, the first layer 15100-1 as described in FIG. 15, a second layer 17330 (for example, the second layer 15330 as described in FIG. 15), and a third layer 17100-2 (for example, the third layer 15100-2 described in FIG. 15).

The first layer 17100-1 and the third layer 17100-2 shown in FIG. 17 are the same as the first layer 15100-1 and the third layer 15100-2 as described in FIG. 15, respectively, Thus, detailed descriptions thereof are omitted.

The second layer 17330 according to the embodiments may include at least one hollow tube 17340. FIG. 17 shows a plurality of hollow tubes 17340. However, the disclosure is not limited thereto. In another example, the second layer 17330 according to the embodiments may include a single hollow tube 17340. The hollow tubes 17340 according to the embodiments may be disposed to be fitted into between the first layer 17100-1 and the third layer 17100-2. That is, the hollow tubes 17340 according to the embodiments is disposed between the FFC of the first layer 17100-1 and the FFC of the third layer 17100-2. The FFC of the first layer 17100-1 adjacent to the hollow tubes 17340 according to embodiments may be a FFC disposed at a bottom of the first layer 17100-1 along the z-axis. The FFC of the third layer 17100-2 adjacent to the hollow tubes 17340 according to the embodiments may be a FFC disposed at a top of the third layer 17100-2 along a z-axis. The hollow tubes 17340 according to the embodiments may dissipate heat discharged from the plurality of FFCs included in each of the first layer 17100-1 and the third layer 17100-2 or the stacked FFCs adjacent to the hollow tube 17340 to the outside. It may be difficult to dissipate heat generated from the plurality of FFCs only using air at room temperature located inside the hollow tubes 17340 according to embodiments. In this case, heat may be released by flowing a fluid such as cooled air or water into the hollow tubes 17340 according to the embodiments.

A cross-sectional shape of each of the hollow tubes 17340 according to the embodiments may be a circular shape (hereinafter, referred to as a “circular hollow tube”). However, the present disclosure is not limited thereto. The cross-sectional shape of the hollow tube 17340 may be a polygonal shape such as a triangle or a pentagon. The hollow tube 17340 may be embodied as an array of the plurality of small circular hollow tubes 17340 as shown in FIG. 17. However, the disclosure is not limited thereto. Although not shown, the hollow tube 17340 may be embodied as a single large circular hollow tube 17340

The hollow tube 17340 according to the embodiments may be made of a conductor. The stack-type busbar 17300 including the hollow tube 17340 according to the embodiments may supply high power. Specifically, the hollow tube 17340 made of the conductor increases a percentage of a conductor included in the stack-type busbar 17300 according to the embodiments, thereby supplying greater power.

The hollow tube 17340 according to the embodiments may be made of an insulator. When the hollow tube 17340 according to the embodiments itself has an insulating effect, it is possible to suppress generation of an electric force between the FFC of the first layer 17100-1 and the FFC of the third layer 17100-2. Therefore, the hollow tube 17340 may suppress an attracting force between the FFC of the first layer 17100-1 and the FFC of the third layer 17100-2 via the electric force, such that a spacing between the first layer 17100-1 and the third layer 17100-2 may be further widened. Thus, the stack-type busbar 17300 including the hollow tube 17340 according to embodiments may more effectively reduce the heat existing in the stack-type busbar 17300

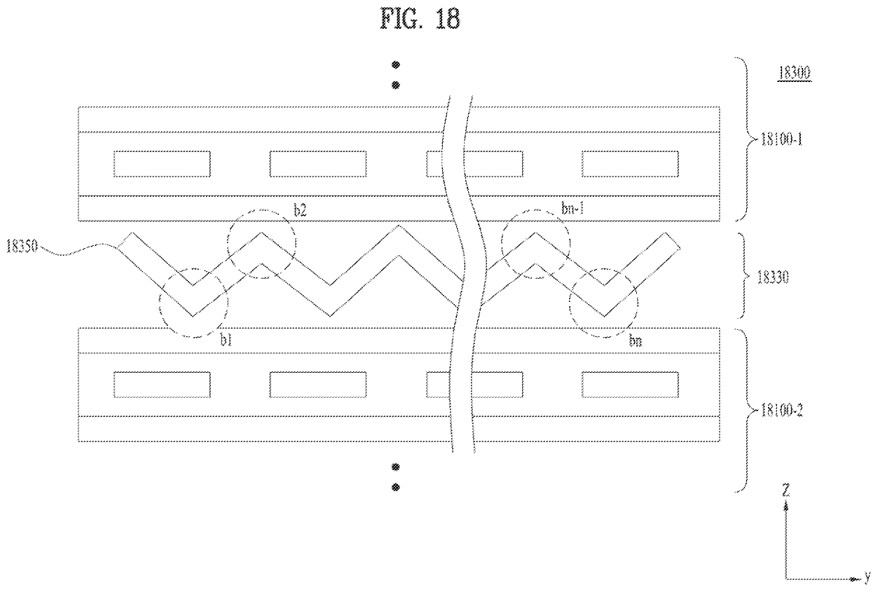

FIG. 18 is a cross-sectional view of a stack-type busbar according to embodiments.

A stack-type busbar 18300 (for example, the stack-type busbar as described in FIGS. 10 to 17) according to embodiments may include one or more layers (for example, the layer described in FIG. 15). FIG. 18 shows the stack-type busbar 18300 composed of three layers, namely, a first layer 18100-1 (for example, the first layer 15100-1 as described in FIG. 15, a second layer 18330 (for example, the second layer 15330 as described in FIG. 15), and a third layer 18100-2 (for example, the third layer 15100-2 described in FIG. 15).

The first layer 18100-1 and the third layer 18100-2 shown in FIG. 18 are the same as the first layer 15100-1 and the third layer 15100-2 as described in FIG. 15, respectively, Thus, detailed descriptions thereof are omitted.

The second layer 18330 according to embodiments may include a bridge 18350. FIG. 18 shows one bridge (18350). However, the disclosure is not limited thereto. In another example, the bridge 18350 according to embodiments may include one or more bridges. The bridge 18350 according to embodiments may be disposed to be sandwiched between the first layer 18100-1 and the third layer 18100-2. That is, the bridge 18350 according to the embodiments is disposed between the FFC of the first layer 18100-1 and the FFC of the third layer 18100-2. The FFC of the first layer 18100-1 adjacent to the bridge 18350 according to embodiments may be a FFC disposed at a bottom of the first layer 18100-1 along the z-axis. The FFC of the third layer 18100-2 adjacent to the bridge 18350 according to the embodiments may be a FFC disposed at a top of the third layer 18100-2 along a z-axis. The bridge 18350 according to the embodiments may increase a spacing between the FFC of the first layer 18100-1 and the FFC of the third layer 18100-2. Specifically, the bridge 18350 according to the embodiments may support the FFC of the first layer 18100-1 and the FFC of the third layer 18100-2 so that the distance between the FFC of the first layer 18100-2 is equal to or greater than a preset distance. The bridge 18350 according to the embodiments may dissipate heat discharged from the plurality of FFCs included in each of the first layer 18100-1 and the third layer 18100-2 or the stacked FFCs adjacent to the bridge 18350 to the outside.

As shown in FIG. 18, the bridge 18350 according to the embodiments may have n bent portions b1, b2, . . . bn−1, bn (hereinafter, collectively referred to as a bent portion b). The number of bent portions b included in the bridge 18350 according to embodiments may vary depending on a purpose and a size of the stack-type busbar 18300. The bridge 18350 according to the embodiments may maintain a vertical dimension of the second layer 18300 at a predetermined size or greater using the bent portion.

The bridge 18350 according to the embodiments may be made of a conductor. The stack-type busbar 18300 including the bridge 18350 according to the embodiments may supply high power. Specifically, the bridge 18350 made of the conductor increases a percentage of a conductor included in the stack-type busbar 18300 according to the embodiments, thereby supplying greater power.

The bridge 18350 according to the embodiments may be made of an insulator. When the bridge 18350 according to the embodiments itself has an insulating effect, it is possible to suppress generation of an electric force between the FFC of the first layer 18100-1 and the FFC of the third layer 18100-2. Therefore, the bridge 18350 may suppress an attracting force between the FFC of the first layer 18100-1 and the FFC of the third layer 18100-2 via the electric force, such that a spacing between the first layer 18100-1 and the third layer 18100-2 may be further widened. Thus, the stack-type busbar 18300 including the bridge 18350 according to embodiments may more effectively reduce the heat existing in the stack-type busbar 18300.

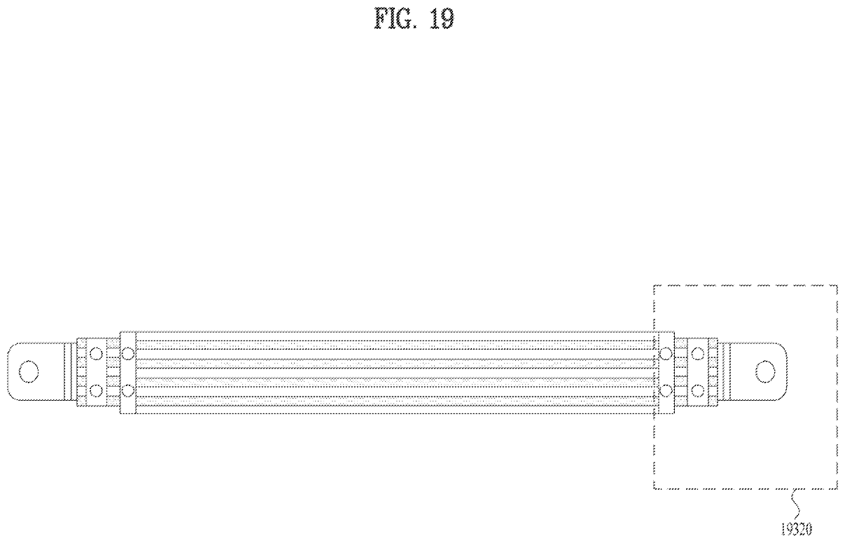

FIG. 19 is a stack-type busbar according to embodiments.

The stack-type busbar (for example, the stack-type busbar as described above with reference to FIG. 10 to FIG. 18) including one or more FFCs according to embodiments (for example, the FCCs as described above with reference to FIG. 1 to FIG. 14) may include a main body (for example, the main body as described above with reference to FIG. 1 and FIG. 10) and a terminal (for example, the terminal as described above with reference to FIG. 1 and FIG. 10). Each of metal structures at both ends of an array of the metal structures (for example, the metal structures as described above with reference to FIGS. 2 to 18) in a horizontal direction extends outwardly of one of the two insulating coating layers in a horizontal direction. The outward extension is referred to as the terminal.

The terminal may be connected to a connector 19320 to connect other electronic components, electronic devices, or electric devices to the busbar. When the stack-type busbar according to the embodiments includes the plurality of FFCs, the connector 19320 may act to connect the FFCs to each other. That is, in the stack-type busbar according to the embodiments, the stacked FFCs are connected to each other via the connector 19320.

When an end of each of the metal structures at both ends of an array of the metal structures is exposed to the outside, a reinforcing film layer may be further disposed on an outer face of the insulating coating layer in order to keep both ends of the FFC flat and to easily couple the connector 19320 to each of both ends of the FFC. For example, when an end of each of the metal structures at both ends of an array of the metal structures is upwardly exposed to the outside, the reinforcing film layer may be disposed on a bottom face of the lower insulating coating layer. Alternatively, when an end of each of the metal structures at both ends of an array of the metal structures is downwardly exposed to the outside, the reinforcing film layer may be disposed on a top face of the upper insulating coating layer. Alternatively, when an end of the metal structure at one of both ends of an array of the metal structures is downwardly exposed to the outside and an end of the metal structure at the other of both ends of an array of the metal structures is upwardly exposed to the outside, one reinforcing film layer is placed on a top face of the upper insulating coating layer, and the other reinforcing film layer is placed on a bottom face of the lower insulating coating layer.

The stack-type busbar according to the embodiments may have a structure in which the plurality of FFCs manufactured via the laminating process according to the embodiments (for example, the laminating process as described above with reference to FIGS. 5 to 9) are vertically stacked.

The connector 19320 according to embodiments may connect the terminals of the plurality of FFCs to each other. Specifically, the connector 15320 may connect the exposed portion of the metal structure at each of both ends of the FFC to a terminal of another FFC. The connector 15320 may connect the terminals of the plurality of FFCs in a rivet manner, a bolt manner, a resistance fusing manner, a pressing manner, or a die casting manner. However, the disclosure is not limited thereto.

The stack-type busbar shown in FIG. 15 includes at least one of the stack structures in FIGS. 12 to 14. For example, the stack-type busbar according to the embodiments may include a combination of the stack structure of FIG. 12 and the stack structure of FIG. 13. Further, the stack-type busbar according to the embodiments may include a combination of the stack structure of FIG. 12 and the stack structure of FIG. 14. The stack-type busbar according to embodiments may include a combination of the stack structure of FIG. 13 and the stack structure of FIG. 14. The stack-type busbar according to embodiments may include a combination of the stack structures of FIGS. 12 and 13 and the stack structure of FIG. 14.

The stack-type busbar shown in FIG. 19 includes at least one of the stack structures of FIGS. 12 to 18. For example, the stack-type busbar according to embodiments may include combinations of at least two of the stack structures of FIGS. 12 to 18.

The FFC according to the embodiments has the insulating coating layer formed by laminating the PCT film, thereby to reduce the weight of the FFC, and improve the thermal emissivity of the FFC.

Further, the FFC according to the embodiments includes a metal structure made of not only copper but also various metal conductors such as sludge metal (for example, iron (Fe), so that the manufacturing cost thereof may be reduced.

Further, the FFC according to the embodiments includes the metal structure whose cross-sectional area is adjusted, such that the thermal resistance of the metal structure may be lowered. The FFC according to the embodiments may include the adhesive made of the material having high thermal emissivity to maintain the temperature of the FFC at a constant level.

Moreover, the stack-type busbar according to the embodiments has a stacked structure capable of improving heat dissipation efficiency even though the plurality of FFCs are vertically stacked.

It will also be understood that, although the terms first, second, etc. are, in some instances, used herein to describe various elements, these elements should not be limited by these terms. These terms are only used to distinguish one element from another. For example, a first user input signal could be termed a second user input signal, and, similarly, a second user input signal could be termed a first user input signal, without departing from the scope of the various described embodiments. The first user input signal and the second user input signal are both user input signals, but they are not the same user input signals, unless the context clearly indicates otherwise.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context. Similarly, the phrase “when it is determined” or “when [a stated condition or event] is detected” is, optionally, construed to mean “upon determining” or “in response to determining” or “upon detecting [the stated condition or event]” or “in response to detecting [the stated condition or event],” depending on the context.

The present disclosure as described above may be subjected to various substitutions, modifications, and changes within the scope of the present disclosure without departing from the technical spirit of the present disclosure by a person having ordinary knowledge in the technical field to which the present disclosure belongs. Thus, the disclosure is not limited to the accompanying drawings.

What is claimed is:

1. A stack-type busbar including a first layer, a second layer, and a third layer,
wherein the first layer is disposed on the second layer, and the second layer is disposed on the third layer,
wherein each of the first layer and the third layer includes:
two insulating coating layers vertically spaced from each other;
a plurality of metal structures disposed between the two insulating coating layers and arranged horizontally and spaced apart from by a predetermined spacing; and
an adhesive filled between the two insulating coating layers to fix the plurality of metal structures while surrounding the plurality of metal structures,
wherein the second layer has a thickness greater than or equal to a predefined value for heat dissipation of the first layer and the third layer,
wherein a spacing between adjacent metal structures included in the first layer is greater than or equal to a spacing between adjacent metal structures included in the third layer.

2. The stack-type busbar of claim 1, wherein each of the plurality of metal structures includes one of iron (Fe), sludge metal, and aluminum (Al).

3. The stack-type busbar of claim 1, wherein each of the two insulating coating layers has thermal emissivity higher than or equal to thermal emissivity of the adhesive,
wherein the adhesive has thermal emissivity higher than or equal to thermal emissivity of each of the plurality of metal structures.

4. The stack-type busbar of claim 1, wherein each of the two insulating coating layers includes a polycyclohexane dimethylene terephthalate (PCT) film.

5. The stack-type busbar of claim 1, wherein the adhesive includes polyester.

6. The stack-type busbar of claim 1, wherein each of the plurality of metal structures has a thickness of 0.2 mm to 0.5 mm and a width of 0.05 mm to 0.15 mm.

7. The stack-type busbar of claim 1, wherein each of the first and third layers is formed using:
a first lamination process in which heat of a temperature within a range of 100° C. to 110° C. and a pressure within a range of 1 kgf/cm² to 3 kgf/cm² are applied to the two insulating coating layers; and then a second lamination process immediately after the first lamination process in which heat of a temperature within a range of 140° C. to 160° C. and a pressure within a range of 90 kgf/cm² to 110 kgf/cm² are applied to the two insulating coating layers.

8. The stack-type busbar of claim 7, wherein the busbar further comprises a reinforcing film formed on an outer face of each of the two insulating coating layers, and located opposite to the metal structures,
wherein the reinforcing film is thermally compressed and bonded to each of the two insulating coating layers using a third lamination process in which a temperature in a range of 110° C. to 130° C. and a pressure in a range of 1 kgf/cm² to 3 kgf/cm² are applied to the reinforcing film and each of the two insulating coating layers.

9. The stack-type busbar of claim 1, wherein each of metal structures at both ends of an array of the metal structures in a horizontal direction in each of the first layer and the third layer extends outwardly of one of the two insulating coating layers in a horizontal direction.

10. The stack-type busbar of claim 1, wherein the busbar further comprises a hollow tube disposed in the second layer, wherein a fluid flows in the hollow tube.

11. The stack-type busbar of claim 1, wherein the stack-type busbar further comprises a bridge disposed in the second layer and configured to maintain a spacing between the first layer and the third layer to be equal to or greater than a predefined spacing.

12. The stack-type busbar of claim 1, wherein the stack-type bus bar further comprises a connector connected to each of metal structures at both ends of an array of the metal structures in a horizontal direction.

13. A stack-type busbar comprising:
a vertical stack of a plurality of flexible flat cables (FFCs);
at least one hollow tube sandwiched between vertically adjacent two FFCs of the plurality of FFCs, wherein a fluid flows in the at least one hollow tube to dissipate heat discharged from the plurality of FFCs; and
a connector connected to each of both ends of each of the plurality of FFCs,
wherein each flexible flat cable (FFC) includes:
two insulating coating layers vertically spaced from each other, wherein each of the two insulating coating layers includes a polycyclohexane dimethylene terephthalate (PCT) film;
a plurality of metal structures disposed between the two insulating coating layers and arranged horizontally and spaced apart from by a predetermined spacing; and
an adhesive filled between the two insulating coating layers to fix the plurality of metal structures while surrounding the plurality of metal structures,
wherein each of the plurality of metal structures includes one of iron (Fe), sludge metal, and aluminum (Al).

14. The stack-type busbar of claim 13, wherein each of the at least one hollow tube has a polygonal shape.

15. The stack-type busbar of claim 13, wherein each of the at least one hollow tube has a circular shape.

16. The stack-type busbar of claim 13, wherein each of the at least one hollow tube is made of an insulators or a conductor.

17. A stack-type busbar comprising:
a vertical stack of a plurality of flexible flat cables (FFCs);
at least one bridge sandwiched between vertically adjacent two FFCs of the plurality of FFCs; and
a connector connected to each of both ends of each of the plurality of FFCs,
wherein each flexible flat cable (FFC) includes:
two insulating coating layers vertically spaced from each other, wherein each of the two insulating coating layers includes a polycyclohexane dimethylene terephthalate (PCT) film;
a plurality of metal structures disposed between the two insulating coating layers and arranged horizontally and spaced apart from by a predetermined spacing; and
an adhesive filled between the two insulating coating layers to fix the plurality of metal structures while surrounding the plurality of metal structures,
wherein each of the plurality of metal structures includes one of iron (Fe), sludge metal, and aluminum (Al),
wherein the at least one bridge maintains a spacing between the vertically adjacent two FFCs to be equal to or greater than a predefined spacing.

18. The stack-type busbar of claim 17, wherein the bridge includes one or more bent portions.

19. The stack-type busbar of claim 17, wherein the bridge is made of a conductor.

20. The stack-type busbar of claim 17, wherein the bridge is made of an insulator.
